(19) United States
(12) Patent Application Publication
(10) Pub. No.: US 2024/0380525 A1
(43) Pub. Date: Nov. 14, 2024

(54) DETERMINING HARQ PROCESS FOR CONFIGURED GRANT RETRANSMISSION

(71) Applicant: Lenovo (Singapore) Pte. Ltd., New Tech Park (SG)

(72) Inventors: Joachim Löhr, Wiesbaden (DE); Alexander Golitschek Edler von Elbwart, Darmstadt (DE)

(21) Appl. No.: 18/683,194

(22) PCT Filed: Aug. 11, 2022
(86) PCT No.: PCT/IB2022/057523

§ 371 Date: Feb. 12, 2024

Related U.S. Application Data
(60) Provisional application No. 63/232,130, filed on Aug. 11, 2021.

(51) Int. Cl. H04L 1/1812; H04W 72/1268; H04W 72/232

(52) U.S. Cl. CPC H04L 1/1819; H04W 72/1268; H04W 72/232

(57) ABSTRACT

Apparatuses, methods, and systems are disclosed for dynamic retransmission for a failed configured grant (CG) transmission. One method includes receiving, at a UE, downlink control information (DCI) scheduling uplink resources for a hybrid automatic repeat request (HARQ) retransmission at a first time-instance, where the DCI includes a first field indicating a CG configuration index. The method includes determining, by the UE, a HARQ process identifier (HPID) based on the CG configuration index signaled within the DCI and triggering, at the UE, a HARQ retransmission for a HARQ process corresponding to the determined HPID.

### CROSS-REFERENCE TO RELATED APPLICATIONS

This application claims priority to U.S. Provisional Patent Application No. 63/232,130 entitled “DYNAMIC RETRANSMISSION FOR CONFIGURED GRANT TRANSMISSIONS” and filed on 11 Aug. 2021 for Joachim Löhr and Alexander Golitschek Edler von Elbwart, which application is incorporated herein by reference.

### FIELD

The subject matter disclosed herein relates generally to wireless communications and more particularly relates to methods and apparatus for dynamic retransmission for Listen-Before-Talk (“LBT”) or Cyclic Redundancy Check (“CRC”) failed Configured Grant (“CG”) Physical Uplink Shared Channel (“PUSCH”) transmissions.

### BACKGROUND

For cases that LBT failure occurs for a PUSCH transmission on a configured uplink grant (referred to as “CG-PUSCH”)—as well as for cases if LBT succeeds, but the PUSCH transmission fails and a gNB cannot decode the corresponding associated CG Uplink Control Information (“CG-UCI”)—it is not possible for a Fifth-Generation (“5G”) Node B (“gNB”) to schedule a dynamic retransmission of the CG-PUSCH transmission, i.e., Downlink Control Information (“DCI”) addressed to Configured Scheduling Radio Network Temporary Identifier (“CS-RNTI”), since the gNB does not know the Hybrid Automatic Repeat Request (“HARQ”) process identifier (“HPID”) selected by the User Equipment (“UE”) for the CG-PUSCH transmission.

### BRIEF SUMMARY

Disclosed are procedures for dynamic retransmission for a failed CG transmission. Said procedures may be implemented by apparatus, systems, methods, or computer program products.

One method at a UE device, includes receiving DCI scheduling uplink (“UL”) resources for a HARQ retransmission at a first time-instance, where the DCI includes a first field indicating a CG configuration index. The method includes determining, by the UE device, a HPID based on the CG configuration index signaled within the DCI and triggering, at the UE device, a HARQ retransmission for a HARQ process corresponding to the determined HPID.

One method at a network device includes determining a CG configuration index corresponding to a particular HARQ process of the UE device and transmitting, to the UE device, a DCI scheduling UL resources for a HARQ retransmission at a first time-instance. Here, the DCI includes a first field indicating the CG configuration index. The method includes monitoring for a HARQ retransmission from the UE device for the particular HARQ process.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for dynamic retransmission for a failed CG transmission;

FIG. 2 is a diagram illustrating one embodiment of a New Radio (“NR”) protocol stack;

FIG. 3 is a diagram illustrating one embodiment of a timeline for dynamic transmission for a failed CG transmission;

FIG. 4 is a diagram illustrating one embodiment of DCI used to schedule dynamic retransmission for a failed CG transmission;

FIG. 5 is a diagram illustrating one embodiment of a radio frame and an LBT procedure for unlicensed communication;

FIG. 6 is a block diagram illustrating one embodiment of a user equipment apparatus that may be used for dynamic retransmission for a failed CG transmission;

FIG. 7 is a block diagram illustrating one embodiment of a network apparatus that may be used for dynamic retransmission for a failed CG transmission;

FIG. 8 is a flowchart diagram illustrating one embodiment of a first method for dynamic retransmission for a failed CG transmission; and

FIG. 9 is a flowchart diagram illustrating one embodiment of a second method for dynamic retransmission for a failed CG transmission.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for dynamic retransmission for a failed CG transmission. A “configured grant” or “CG” refers to a semi-persistent grant of radio resources, where a transmission during a CG occasion does not require dynamic scheduling of the radio resources. Accordingly, a CG transmission may also be referred to as a transmission-without-grant or a data transmission without resource request.

In Third Generation Partnership Project (“3GPP”) wireless networks, a PUSCH transmission can be dynamically scheduled using an UL grant in UL DCI, e.g., using DCI format 0_0 or DCI format 0_1, or using an UL grant in a Random Access Response (“RAR”) message. Alternatively, a PUSCH transmission can be a semi-statically configured UL grant, e.g., corresponding to a CG configuration.

There are two types of transmission without dynamic grant, known as CG Type 1 and CG Type 2. Both CG Type 1 and CG Type 2 grants are configured by Radio Resource Control (“RRC”) signaling per serving cell and per bandwidth part (“BWP”). For CG Type 1, an UL grant is provided by RRC to activate the CG configuration. For CG Type 2, an UL grant is provided by Physical Downlink Control Channel (“PDCCH”) to activate or deactivate a CG configuration, e.g., based on physical layer signaling. As used herein, a “bandwidth part” or “BWP” is a 3GPP NR feature for dynamically adapting the carrier bandwidth (and/or the numerology) in which the UE operates. Each BWP is a contiguous set of physical resource blocks (“PRBs”) and comprises a subset of the carrier bandwidth. The UE is not expected to receive Physical Downlink Shared Channel (“PDSCH”), PDCCH, Channel State Information Reference Signals (“CSI-RS”), or tracking reference signals (“TRS”) outside an active downlink (“DL”) BWP and the UE shall not transmit PUSCH or Physical Uplink Control Channel (“PUCCH”) outside an active UL BWP.

Multiple configurations can be active simultaneously on a serving cell. For Type 2 grant, activation and deactivation are independent among the CG configurations. When the CG Type 1 is used, the RRC configures the following parameters: a CS-RNTI for retransmission; a periodicity of the CG Type 1; the offset of a resource with respect to the time domain; time-domain parameters which include the start symbol and the length of the assignment; as well as the number of HARQ processes. Alternatively, when the CG Type 2 is going to be used, the RRC configures the following parameters: a CS-RNTI for activation, deactivation, and retransmission; the periodicity of the CG Type 2; and the number of HARQ processes.

Once a CG Type 1 semi-persistent allocation is set up in a serving cell by upper layers, the corresponding Medium Access Control (“MAC”) entity stores the UL grant provided by upper layers and initializes the configured UL grant to start in the symbol according to the provided parameters.

For cases that LBT failure occurs for a PUSCH transmission on a configured UL grant (i.e., CG-PUSCH), as well as for cases where LBT succeeds, but the PUSCH transmission fails and the gNB cannot decode the corresponding associated CG-UCI, it is basically not possible for the gNB to schedule a dynamic retransmission of the CG-PUSCH transmission, i.e. DCI addressed to CS-RNTI, since the gNB does not know the HPID selected by the UE for the CG-PUSCH transmission.

Consequently, the network needs to rely on the UE autonomous retransmission mechanism, i.e., the UE autonomously retransmits the pending respectively unsuccessfully transmitted protocol data unit (“PDU”) on a next compatible CG occasion after cg-RetransmissionTimer has expired, e.g., no Downlink Feedback Indicator (“DFI”) is received. For Ultra-Reliable and Low-Latency Communications (“URLLC”) traffic with a larger periodicity, the fact that the gNB cannot schedule a dynamic retransmission might result in delayed transmission, i.e., the autonomous retransmission has to wait for the next available CG resource to take place.

A further consequence will be that subsequent initial transmission are also delayed. If the retransmission can only occur on CGs, considering the retransmissions are prioritized over new transmissions, a new initial transmission (on CG resources) will be also delayed. The root of the problem that the gNB cannot schedule dynamic retransmission for recovering LBT-failed or CRC-failed transmissions on CG is that the gNB has not received the CG-UCI, i.e., uplink control information (“UCI”) associated with the CG-PUSCH transmission, and hence cannot identify the UE-selected HPID. Note that reliance on UE-autonomous retransmissions may lead to delayed retransmissions and delayed subsequent initial transmissions.

Disclosed are solutions for dynamic retransmission for a failed CG transmission. The solutions may be implemented by apparatus, systems, methods, or computer program products. In some embodiments, a radio access network (“RAN”) may support dynamic retransmission for failed CG-PUSCH transmissions, e.g., due to LBT failure or unsuccessful reception of CG-UCI. In some embodiments, the uplink (re-)transmission grant, i.e., UL DCI, indicates the CG configuration index for which a HARQ retransmission is requested, e.g., HPID is not known by the gNB. In certain embodiments, the UL DCI schedules a HARQ retransmission for the last CG occasion of the CG configuration indicated within the DCI.

In certain embodiments, the parameter ConfiguredGrantConfigIndex is signaled by the HARQ process number field in UL DCI. In certain embodiments, there is a new indication within the UL DCI indicating how to interpret the HARQ process number field. In some embodiments, the UL DCI indicates the indicates the ‘x’ last CG occasion before reception of the DCI across all CG configurations for which a HARQ retransmission is requested/scheduled.

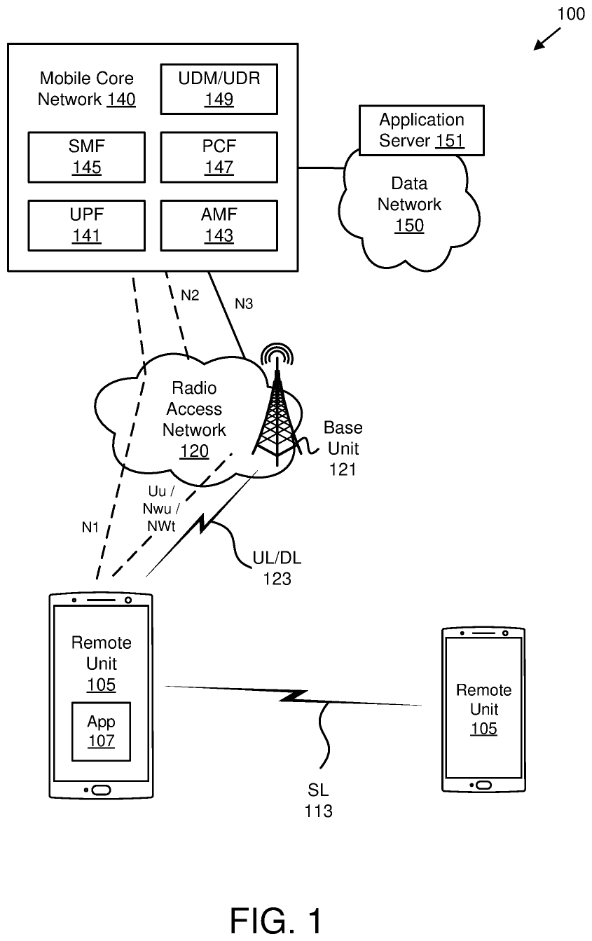

FIG. 1 depicts a wireless communication system 100 for dynamic retransmission for a failed CG transmission, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G cellular system specified in the 3GPP specifications. For example, the RAN 120 may be a Next Generation Radio Access Network (“NG-RAN”), implementing NR Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via UL and DL communication signals. Furthermore, the UL and DL communication signals may be carried over the wireless communication links 123. Furthermore, the UL communication signals may comprise one or more UL channels, such as the PUCCH and/or PUSCH, while the DL communication signals may comprise one or more DL channels, such as the PDCCH and/or PDSCH. Here, the RAN 120 is an intermediate network that provides the remote units 105 with access to the mobile core network 140.

In various embodiments, the remote units 105 may communicate directly with each other (e.g., device-to-device communication) using sidelink communication 113. Here, sidelink transmissions may occur on sidelink resources. A remote unit 105 may be provided with different sidelink communication resources according to different allocation modes. As used herein, a “resource pool” refers to a set of resources assigned for sidelink operation. A resource pool consists of a set of resource blocks (i.e., PRBs) over one or more time-units (e.g., subframe, slots, Orthogonal Frequency Division Multiplexing (“OFDM”) symbols). In some embodiments, the set of resource blocks comprises contiguous PRBs in the frequency domain. A Physical Resource Block (“PRB”), as used herein, consists of twelve consecutive subcarriers in the frequency domain.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a PDU session (or Packet Data Network (“PDN”) connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, abase station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

Note that during NR operation in Unlicensed Spectrum (referred to as “NR-U”), the base unit 121 and the remote unit 105 communicate over unlicensed (i.e., shared) radio spectrum. Similarly, during LTE operation in Unlicensed Spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of NFs are depicted in FIG. 1, one of skill in the art will recognize that any number and type of NFs may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of NFs. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for URLLC service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of NFs, such as the SMF 145 and UPF 141. In some embodiments, the different network slices may share some common NFs, such as the AMF 143. The different network slices are not shown in FIG. 1 for ease of illustration, but their support is assumed.

While FIG. 1 depicts components of a 5G RAN and a 5G core network, the described embodiments for dynamic retransmission for a failed CG transmission apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted NFs may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a CP portion of a PGW and/or to an MME, the UPF 141 may be mapped to an SGW and a UP portion of the PGW, the UDM/UDR 149 may be mapped to an HSS, etc.

In the following descriptions, the term “gNB” is used for the base station/base unit, but it is replaceable by any other radio access node, e.g., RAN node, ng-eNB, eNB, Base Station (“BS”), Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for dynamic retransmission for a failed CG transmission.

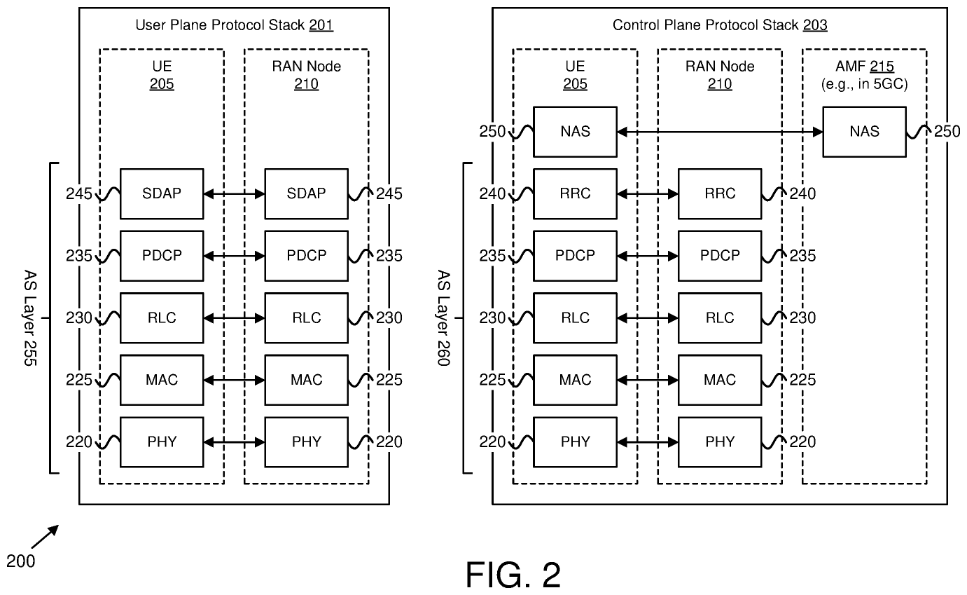

FIG. 2 depicts a NR protocol stack 200, according to embodiments of the disclosure. While FIG. 2 shows the UE 205, the RAN node 210 and an AMF 215 in a 5GC, these are representative of a set of remote units 105 interacting with a base unit 121 and a mobile core network 140. As depicted, the NR protocol stack 200 comprises a User Plane protocol stack 201 and a Control Plane protocol stack 203. The User Plane protocol stack 201 includes a physical (“PHY”) layer 220, a MAC sublayer 225, the Radio Link Control (“RLC”) sublayer 230, a Packet Data Convergence Protocol (“PDCP”) sublayer 235, and Service Data Adaptation Protocol (“SDAP”) layer 240. The Control Plane protocol stack 203 includes a PHY layer 220, a MAC sublayer 225, a RLC sublayer 230, and a PDCP sublayer 235. The Control Plane protocol stack 203 also includes a RRC layer 245 and a NAS layer 250.

The Access Stratum (“AS”) layer 255 (also referred to as “AS protocol stack”) for the User Plane protocol stack 201 consists of at least the SDAP layer 240, PDCP sublayer 235, RLC sublayer 230, and MAC sublayer 225, and the PHY layer 220. The AS layer 260 for the Control Plane protocol stack 203 consists of at least the RRC layer 245, PDCP sublayer 235, RLC sublayer 230 and MAC sublayer 225, and the PHY layer 220. The Layer-2 (“L2”) is split into the SDAP layer 240, PDCP sublayer 235, RLC sublayer 230 and MAC sublayer 225. The Layer-3 (“L3”) includes the RRC layer 245 and the NAS layer 250 for the CP and includes, e.g., an IP layer and/or PDU Layer (not depicted) for the UP. L1 and L2 are referred to as “lower layers,” while L3 and above (e.g., transport layer, application layer) are referred to as “higher layers” or “upper layers.”

The PHY layer 220 offers transport channels to the MAC sublayer 225. The PHY layer 220 may perform a beam failure detection procedure using energy detection thresholds, as described herein. In certain embodiments, the PHY layer 220 may send an indication of beam failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and the AMF 215 in the 5GC. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 between the UE 205 and the RAN (i.e., RAN node 210) and carries information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC sublayer 230 above is through logical channels. The MAC sublayer 225 therefore performs multiplexing and demultiplexing between logical channels and transport channels: the MAC sublayer 225 in the transmitting side constructs MAC PDUs, known as transport blocks, from MAC Service Data Units (“SDUs”) received through logical channels, and the MAC sublayer 225 in the receiving side recovers MAC SDUs from MAC PDUs received through transport channels.

The MAC sublayer 225 provides a data transfer service for the RLC sublayer 230 through logical channels, which are either control logical channels which carry CP data (e.g., RRC signaling) or traffic logical channels which carry UP data. On the other hand, the data from the MAC sublayer 225 is exchanged with the PHY layer 220 through transport channels, which are classified as DL or UL. Data is multiplexed into transport channels depending on how it is transmitted over the air.

The PHY layer 220 is responsible for the actual transmission of data and control information via the air interface, i.e., the PHY layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of physical resource blocks, etc.

Regarding UL Grant Reception, UL grant is either received dynamically on the PDCCH, in a RAR, configured semi-persistently by RRC or determined to be associated with the PUSCH resource of Message A (“MsgA,” refers to the first message of a 2-step random access procedure), e.g., as specified in clause 5.1.2a of 3GPP Technical Specification (“TS”) 38.321. The MAC entity shall have an UL grant to transmit on the Uplink Shared Channel (“UL-SCH”). To perform the requested transmissions, the MAC layer receives HARQ information from lower layers. An UL grant addressed to CS-RNTI with New Data Indicator (“NDI”)=0 is considered as a configured UL grant. An UL grant addressed to CS-RNTI with NDI=1 is considered as a dynamic UL grant.

If the MAC entity has a Cell Radio Network Temporary Identifier (“C-RNTI”), a Temporary C-RNTI, or CS-RNTI, the MAC entity shall for each PDCCH occasion and for each Serving Cell belonging to a Timing Advance Group (“TAG”) that has a running timeAlignmentTimer and for each grant received for this PDCCH occasion:
1> if an UL grant for this Serving Cell has been received on the PDCCH for the MAC entity's C-RNTI or Temporary C-RNTI; or
1> if an UL grant has been received in a RAR:
   2> if the UL grant is for MAC entity's C-RNTI and if the previous UL grant delivered to the HARQ entity for the same HARQ process was either an UL grant received for the MAC entity's CS-RNTI or a configured UL grant:
      3> consider the NDI to have been toggled for the corresponding HARQ process regardless of the value of the NDI.
   2> if the UL grant is for MAC entity's C-RNTI, and the identified HARQ process is configured for a configured UL grant:
      3> start or restart the configuredGrantTimer for the corresponding HARQ process, if configured.
      3> stop the cg-RetransmissionTimer for the corresponding HARQ process, if running.
   2> deliver the UL grant and the associated HARQ information to the HARQ entity.
1> else if an UL grant for this PDCCH occasion has been received for this Serving Cell on the PDCCH for the MAC entity's CS-RNTI:
   2> if the NDI in the received HARQ information is 1:
      3> consider the NDI for the corresponding HARQ process not to have been toggled;
      3> start or restart the configuredGrantTimer for the corresponding HARQ process, if configured;
      3> stop the cg-RetransmissionTimer for the corresponding HARQ process, if running;
      3> deliver the UL grant and the associated HARQ information to the HARQ entity.
   2> else if the NDI in the received HARQ information is 0:
      3> if PDCCH contents indicate CG Type 2 deactivation:
         4> trigger configured UL grant confirmation.
      3> else if PDCCH contents indicate CG Type 2 activation:
         4> trigger configured UL grant confirmation;
         4> store the UL grant for this Serving Cell and the associated HARQ information as configured UL grant;
         4> initialize or re-initialize the configured UL grant for this Serving Cell to start in the associated PUSCH duration and to recur according to rules in clause 5.8.2;
         4> stop the configuredGrantTimer for the corresponding HARQ process, if running;
         4> stop the cg-RetransmissionTimer for the corresponding HARQ process, if running.

For each Serving Cell and each configured UL grant, if configured and activated, the MAC entity shall:
1> if the MAC entity is configured with lch-basedPrioritization, and the PUSCH duration of the configured UL grant does not overlap with the PUSCH duration of an UL grant received in a RAR or with the PUSCH duration of an UL grant addressed to Temporary C-RNTI or the PUSCH duration of a MsgA payload for this Serving Cell; or
1> if the MAC entity is not configured with lch-basedPrioritization, and the PUSCH duration of the configured UL grant does not overlap with the PUSCH duration of an UL grant received on the PDCCH or in a RAR or the PUSCH duration of a MsgA payload for this Serving Cell:
   2> set the HPID to the HPID associated with this PUSCH duration;
   2> if, for the corresponding HARQ process, the configuredGrantTimer is not running and cg-RetransmissionTimer is not configured (i.e., new transmission):
      3> consider the NDI bit for the corresponding HARQ process to have been toggled;
      3> deliver the configured UL grant and the associated HARQ information to the HARQ entity.
   2> else if the cg-RetransmissionTimer for the corresponding HARQ process is configured and not running, then for the corresponding HARQ process:
      3> if the configuredGrantTimer is not running, and the HARQ process is not pending (i.e., new transmission):
         4> consider the NDI bit to have been toggled;
         4> deliver the configured UL grant and the associated HARQ information to the HARQ entity.
      3> else if the previous UL grant delivered to the HARQ entity for the same HARQ process was a configured UL grant (i.e., retransmission on CG):
         4> deliver the configured UL grant and the associated HARQ information to the HARQ entity.

For configured UL grants neither configured with harq-ProcID-Offset2 nor with cg-RetransmissionTimer, the HPID associated with the first symbol of a UL transmission is derived from the following equation:

HPID=[floor(CURRENT_symbol/periodicity)]modulo nrofHARQ-Processes

Note that CURRENT_symbol refers to the symbol index of the first transmission occasion of a bundle of configured UL grant.

For, Industrial Internet-of-Things (“IIoT”) (or URLLC), for configured UL grants with harq-ProcID-Offset2, the HPID associated with the first symbol of an UL transmission is derived from the following equation:

HPID=[floor(CURRENT_symbol/periodicity)]modulo nrofHARQ-Processes+harq-ProcID-Offset2

where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot, respectively, e.g., as specified in 3GPP TS 38.211.

For NR-U, for configured UL grants configured with cg-RetransmissionTimer, the UE implementation selects an HPID among the HPIDs available for the CG configuration. The UE shall prioritize retransmissions before initial transmissions. The UE shall toggle the NDI in the CG-UCI for new transmissions and not toggle the NDI in the CG-UCI in retransmissions. Note that if cg-RetransmissionTimer is not configured, a HARQ process is not shared between different CG configurations in the same BWP.

Note that a HARQ process is configured for a configured UL grant where neither harq-ProcID-Offset nor harq-ProcID-Offset2 is configured, if the configured UL grant is activated and the associated HPID is less than nrofHARQ-Processes. A HARQ process is configured for a configured UL grant where harq-ProcID-Offset2 is configured, if the configured UL grant is activated and the associated HPID is greater than or equal to harq-ProcID-Offset2 and less than sum of harq-ProcID-Offset2 and nrofHARQ-Processes for the CG configuration.

Note that if the MAC entity receives a grant in a RAR (i.e. MAC RAR or fallbackRAR) or determines a grant as specified in clause 5.1.2a for MsgA payload and if the MAC entity also receives an overlapping grant for its C-RNTI or CS-RNTI, requiring concurrent transmissions on the Special Cell (“SpCell,” i.e., Primary Cell (“PCell”) or Primary Secondary Cell (“PSCell”)), the MAC entity may choose to continue with either the grant for its Random Access Radio Network Temporary Identifier (“RA-RNTI”), or MsgB Radio Network Temporary Identifier (“MsgB-RNTI”) and/or the MsgA payload transmission or the grant for its C-RNTI or CS-RNTI. Note that “MsgB” refers to the second message of a 2-step random access procedure.

Note that in case of unaligned System Frame Number (“SFN”) across carriers in a cell group, the SFN of the concerned Serving Cell is used to calculate the HPID used for configured UL grants.

According to the above, the HPID selection is different between NR-U and IIoT. For NR-U, UE implementation selects the HPID for a CG-PUSCH transmission, i.e., UL transmission on a configured UL grant. The selected HPID is indicated to the gNB within the CG-UCI. For IIoT (or URLLC) there is a formula which determines based on the time/slot number the HPID to be used for a CG-PUSCH transmission.

Each HARQ process is associated with a HARQ buffer. New transmissions are performed on the resource and with the MCS indicated on PDCCH or indicated in the RAR (i.e., MAC RAR or fallbackRAR), or signaled in RRC or determined as specified in clause 5.1.2a for MsgA payload. Retransmissions are performed on the resource and, if provided, with the MCS indicated on PDCCH, or on the same resource and with the same MCS as was used for last made transmission attempt within a bundle, or on stored configured UL grant resources and stored MCS when cg-RetransmissionTimer is configured. If cg-RetransmissionTimer is configured, retransmissions with the same HARQ process may be performed on any CG configuration if the CG configurations have the same transport block size (“TBS”).

According to embodiments of a first solution, an UL (re-)transmission grant, i.e., UL DCI, for CG transmissions (i.e., CG-PUSCH) contains a field indicating the CG configuration index, e.g., also referred to as ConfiguredGrantConfigIndex, for which the (re-)transmission is requested/scheduled.

According to one implementation of the first solution, the UL DCI, e.g., DCI format 0_0 or 0_1, has a CRC scrambled by CS-RNTI. The CG configuration index, e.g., ConfiguredGrantConfigIndex, indicates the CG configuration for which a HARQ (re-)transmission is requested respectively scheduled. In case of LBT failure or unsuccessful decoding of the CG-UCI accompanying a CG-PUSCH, the gNB is not aware of the HARQ process number/ID selected by the UE implementation for a CG-PUSCH transmission. Therefore, in order to be able to dynamically schedule a HARQ (re-)transmission for a, e.g., LBT-failed initial transmission on a CG resource, the gNB indicates within the DCI the CG configuration index for which the HARQ (re-)transmission is requested/scheduled.

It should be noted that from a UE's perspective the DCI may be seen as a retransmission attempt for an already generated transport block, since the transport block had been generated prior to the transmission attempt that failed due to a busy channel (leading to an LBT failure). It would also be seen as a retransmission from the UE's perspective if the transmission was successful, but the reception failed, e.g., due to noise.

From the gNB's perspective, both cases may be seen as scheduling an initial transmission however, as the gNB has not been able to read the CG-UCI due to corruption, e.g., by noise or due to a failed transmission attempt caused by, e.g., a busy channel. For example, if LBT fails for the initial transmission on a CG resource of the CG configuration with index 2, the UL DCI scheduling a dynamic (re-)transmission for the LBT-failed CG-PUSCH transmission contains a field indicating the CG configuration index set to 2. Based on the received CG configuration index field the UE knows for which CG-PUSCH transmission to perform a HARQ (re-)transmission. The UE maps the CG configuration index signaled within the UL DCI to the HPID used for the last CG occasion of the indicated CG configuration.

In a specific implementation of the first solution, the UE further checks that the NDI field included in the UL DCI is set to 1 as a prerequisite of treating the UL DCI as requesting/scheduling a HARQ (re-)transmission.

In a specific implementation of the first solution, the UE further checks that the CRC for the UL DCI is scrambled by CS-RNTI as a prerequisite of treating the UL DCI as requesting/scheduling a HARQ (re-)transmission; an alternative is to check that the UL grant has been received for the MAC entity's CS-RNTI.

In another implementation of the first solution, the UE checks the NDI in the UL DCI to determine whether a retransmission for the data of the corresponding HARQ process is requested, or a new transport block is requested.

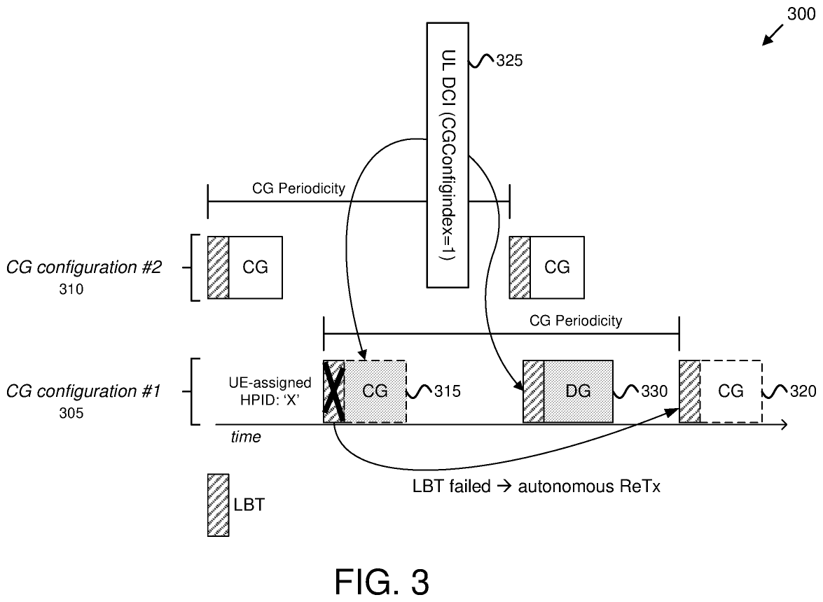

FIG. 3 illustrates one exemplary timeline 300 for dynamic retransmission for a failed CG transmission, according to embodiments of the first solution. As shown here, a UE (e.g., the UE 205 and/or the remote unit 105) is configured with two CG configurations: a first CG configuration (denoted “CG configuration #1”) 305 and a second CG configuration (denoted “CG configuration #2”) 310. Note that the first CG configuration 305 has a different offset (in the time domain) and a different periodicity than the second CG configuration 310.

For CG configuration #1, the UE generates a transport block (“TB”) and selects HARQ process ‘X’ for transmission of the TB on a CG occasion 315 of CG configuration #1. However, in the depicted timeline 300, it is assumed that LBT fails for the CG occasion 315. Since LBT fails for the CG occasion 315, the UE considers the selected HARQ process (i.e., HPID ‘X’) as pending and the UE schedules autonomous retransmission of the generated TB for the next CG occasion 320 for this first CG configuration 305.

However, in order to speed up the retransmission of the TB, the gNB schedules a dynamic (re-)transmission of the TB, e.g., by transmitting the UL DCI 325 which schedules a dynamic grant (“DG”) 330. Since the gNB is not aware of the selected HARQ process number (e.g., HPID) for the transmission, i.e., HPID ‘X,’ the gNB indicates within the UL DCI 325 according to this embodiment, the CG configuration index for which the HARQ (re-)transmission is requested. Consequently, the UL DCI 325 contains a field indicating the ConfiguredGrantConfigIndex set to #1.

Upon reception of the UL DCI 325, the UE determines which HARQ process (i.e., HPID) had been employed in the latest (i.e., most recent) transmission occasion of the indicated CG configuration ConfiguredGrantConfigIndex (i.e., the first CG configuration 305). Accordingly, the UE performs a retransmission for the HARQ process corresponding to HPID ‘X’ on the dynamically allocated UL resources, i.e., the DG 320.

According to one implementation of the first solution, the HARQ process number/ID field is reused to signal the CG configuration index, e.g., ConfiguredGrantConfigIndex. Instead of signaling the HARQ process number within the (re-)transmission grant, i.e., UL DCI, which is not known by the gNB in some scenarios such as due to LBT failure, the gNB indicates the CG configuration index within the HARQ process number field.

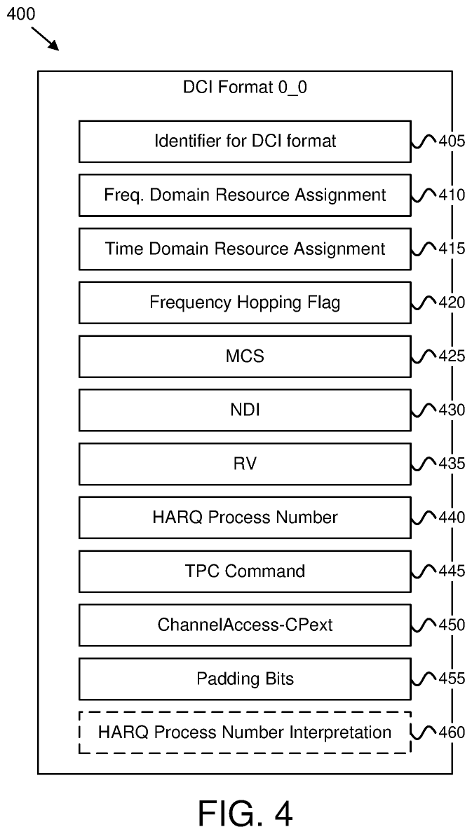

FIG. 4 depicts an example of DCI 400 used for dynamic retransmission for a failed CG transmission, according to embodiments of the disclosure. In various embodiments, the DCI 400 comprises DCI format 0_0 as defined in the 3GPP specification, or a modification to DCI format 0_0, as described below. The following information is transmitted by means of the DCI format 0_0 with CRC scrambled by C-RNTI or CS-RNTI or Configured Scheduling Configured Grant Radio Network Temporary Identifier (“CS-CG-RNTI”) or Modulation-and-Coding-Scheme C-RNTI (“MCS-C-RNTI”):

Identifier (“ID”) for DCI formats 405. In some embodiments, this is a 1-bit field. In various embodiments, the value of this bit field is always set to 0, indicating an UL DCI format.

Frequency domain resource assignment 410. The length of this field varies according to whether the higher layer parameters useInterlacePUCCH-PUSCH in BWP-UplinkCommon or useInterlacePUCCH-PUSCH in BWP-UplinkDedicated are configured. The size and value of this field may be as defined in Clause 6.1.2.2 of 3GPP TS 38.214.

Time domain resource assignment 415. In some embodiments, this is a 4-bit field. The value of this field may be as defined in Clause 6.1.2.1 of 3GPP TS 38.214.

Frequency hopping flag 420. In some embodiments, this is a 1-bit field, e.g., according to Table 7.3.1.1.1-3 of 3GPP TS 38.212. The value of this field may be as defined in 6.3 of 3GPP TS 38.214.

MCS 425. In some embodiments, this is a 5-bit field. The value of this field may be as defined in Clause 6.1.4.1 of 3GPP TS 38.214.

NDI 430. In some embodiments, this is a 1-bit field. The NDI is toggled (from the previous value) to indicate that the resource assignment is for new data. The NDI is left the same (i.e., not toggled) to indicate that the resource assignment is for a retransmission.

Redundancy version (“RV”) 435. In some embodiments, this is a 2-bit field. The value of this field may be as defined in Table 7.3.1.1.1-2 of 3GPP TS 38.212.

HARQ process number 440. In some embodiments, this is a 4-bit field. In some embodiments, this field indicated a HARQ process. In other embodiments, this field may be reused to indicate a CG configuration index.

Transmit Power Control (“TPC”) command 445 for scheduled PUSCH. In some embodiments, this is a 2-bit field. The value of this field may be as defined in Clause 7.1.1 of 3GPP TS 38.213.

ChannelAccess-CPext 450. In some embodiments, this is a 2-bit field. The value of this field indicates combinations of channel access type and CP extension, e.g., as defined in Table 7.3.1.1.1-4 of 3GPP TS 38.212 for operation in a cell with shared spectrum channel access; 0 bits otherwise.

Padding bits 455, if required.

In some embodiments, the DCI Format 0_0 may include a normal UL or Supplementary Uplink (“SUL”) indicator (referred to as “UL/SUL” indicator). In certain embodiments, this is a 1-bit field for UEs configured with supplementaryUplink in ServingCellConfig in the cell; 0 bits otherwise. The UL/SUL indicator, if present, locates in the last bit position of DCI format 0_0, after the padding bit(s), as defined in Clause 7.3.1.1.1 of 3GPP TS 38.212.

In order to unambiguously indicate that the bits of the HARQ process number field should be understood as a CG configuration index, according to one implementation of the first solution, the DCI contains a new indicator/field which indicates how to interpret the HARQ process number field, i.e., either as a HARQ process number or as CG configuration index. According to one specific implementation, the DCI 400 (e.g., DCI format 0_0) includes a new HARQ process number interpretation field 460, e.g., one-bit flag is signaled within the UL DCI which indicates whether the value of the HARQ process number field should be interpreted as the HARQ process number or the ConfiguredGrantConfigIndex. The presence of this new HARQ process number interpretation field 460 could be configurable.

In one example, the new HARQ process number interpretation field 406 may be set to ‘1’ to indicate that the value of the HARQ process number field indicates a ConfiguredGrantConfigIndex. In this case, the UE should determine the corresponding HARQ process number according to one of the described embodiments and implementations, e.g., number/ID of the HARQ process associated with the last CG occasion (before reception of the UL DCI) of the indicated CG configuration. Similarly, the HARQ process number interpretation field 600 may be set to ‘0’ to indicate, according to one example, that the HARQ process number field should be interpreted as in the legacy, i.e., value indicates the HARQ process number.

According to one further implementation of the first solution, an RNTI is used to scramble the CRC of the UL DCI is used to signal/determine whether the HARQ process number field within the UL DCI indicates a HARQ process number (as in the legacy system) or a ConfiguredGrantConfigIndex. To be more specific, if the CRC of the UL DCI is scrambled with a CS-RNTI, the HARQ process number field within the UL DCI indicates a HARQ process number. If the CRC of the UL DCI is scrambled with a new CG-specific RNTI (e.g., called CS-CG-RNTI), which is different from the CS-RNTI, the HARQ process number field within the UL DCI indicates a ConfiguredGrantConfigIndex.

According to one further implementation of the first solution, a new ConfiguredGrantConfigIndex field is signaled within the UL DCI, which indicates for which CG configuration a HARQ retransmission is requested. To be more specific, the field request a retransmission for the HARQ process associated with the last CG occasion (before reception of the UL DCI) of the CG configuration with the same value as provided by the ConfiguredGrantConfigIndex field.

According to embodiments of a second solution, an UL (re-)transmission grant, i.e., UL DCI, for CG transmissions (e.g., for CG-PUSCH) contains a field indicating the CG-PUSCH transmission opportunity/CG occasion for which a (re-)transmission is requested.

According to one implementation the DCI signals the CG occasion number relative to the received DCI, e.g., PDCCH occasion on which the DCI was received, for which the HARQ (re-)transmission request applies to. For example, if the value of this field is set to ‘1’, it indicates that the (re-)transmission is requested for the last CG occasion before the DCI. Similarly, if the value if the field is set to ‘2’, it indicates that a HARQ (re-)transmission is requested for the second last CG occasion (transmission opportunity) before the reception of the DCI.

It should be noted that if a UE is provided more than one configuration for UL CG(s), the new field indicates the ‘x’ last CG occasion before reception of the DCI across all CG configurations, e.g., within the same BWP.

For cases that the UE may have multiple CG occasions in one slot/symbol, e.g., overlapping CG occasions, the CG occasions may be numbered/referred to in a frequency and/or resource block (“RB”) domain order, e.g., lowest CG occasion in frequency domain with respective to PRB 0 has the lowest index/number, in order to make sure that there is no ambiguity to which CG occasion the DCI (new field in the DCI refers to).

According to an embodiment of the second solution, a UE indicates to a gNB whether it is capable of determining the HPID from an indicated ConfiguredGrantConfigIndex. According to another embodiment of the second solution, a UE indicates to a gNB whether it is capable of determining the HPID from a subframe index of a CG occasion.

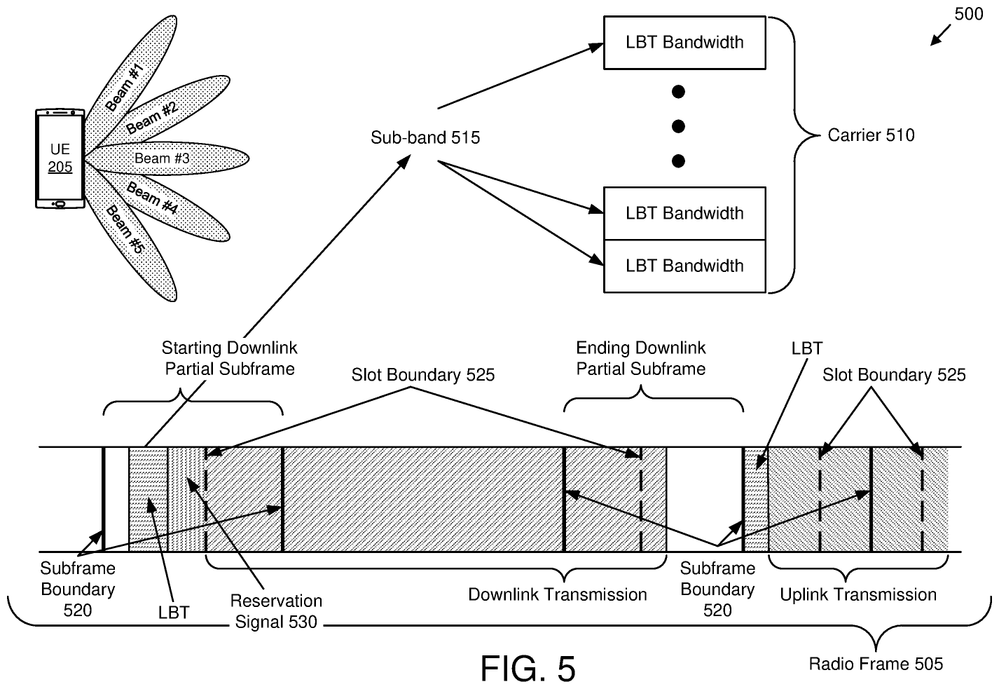

FIG. 5 depicts an LBT procedure 500 for a radio frame 505 for unlicensed communication, according to embodiments of the disclosure. When a communication channel is a wide bandwidth unlicensed carrier 510 (e.g., several hundred MHz, the CCA/LBT procedure relies on detecting the energy level on multiple sub-bands 515 of the communications channel as shown in FIG. 5. The LBT parameters (such as type/duration, clear channel assessment parameters, etc.) may be configured in the UE 205 by the RAN node 210. In one embodiment, the LBT procedure is performed at the PHY layer 220.

When performing omni-directional LBT, the entity (i.e., UE or RAN node) may use an omnidirectional sensing beam. Alternatively, the entity may simultaneously perform directional LBT using multiple beams (i.e., corresponding to multiple device panels) in order to simulate omnidirectional sensing. When performing directional LBT, the entity (i.e., UE or RAN node) performs LBT for a given beam (i.e., corresponding to a given spatial direction). Note that each directional beam may correspond to one or more device panels.

FIG. 5 also depicts frame structure of the radio frame 505 for unlicensed communication between the UE 205 and RAN node 210. The radio frame 505 may be divided into subframes (indicated by subframe boundaries 520) and may be further divided into slots (indicated by slot boundaries 525). The radio frame 505 uses a flexible arrangements where UL and DL operations are on the same frequency channel but are separated in time. However, the subframes are not configured as a DL subframe or an UL subframe and a particular subframe may be used by either the UE 205 or RAN node 210. As discussed previously, LBT is performed prior to a transmission. Where LBT does not coincide with a slot boundary 525, a reservation signal 530 may be transmitted to reserve (i.e., occupy) the channel until the slot boundary is reached and data transmission begins.

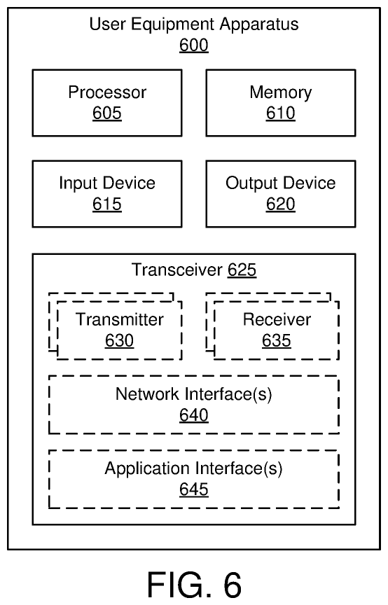

FIG. 6 depicts a user equipment apparatus 600 that may be used for dynamic retransmission for a failed CG transmission, according to embodiments of the disclosure. In various embodiments, the user equipment apparatus 600 is used to implement one or more of the solutions described above. The user equipment apparatus 600 may be one embodiment of a UE endpoint, such as the remote unit 105 and/or the UE 205, as described above. Furthermore, the user equipment apparatus 600 may include a processor 605, a memory 610, an input device 615, an output device 620, and a transceiver 625.

In some embodiments, the input device 615 and the output device 620 are combined into a single device, such as a touchscreen. In certain embodiments, the user equipment apparatus 600 may not include any input device 615 and/or output device 620. In various embodiments, the user equipment apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. In some embodiments, the transceiver 625 communicates with one or more cells (or wireless coverage areas) supported by one or more base units 121. In various embodiments, the transceiver 625 is operable on unlicensed spectrum. Moreover, the transceiver 625 may include multiple UE panels supporting one or more beams. Additionally, the transceiver 625 may support at least one network interface 640 and/or application interface 645. The application interface(s) 645 may support one or more APIs. The network interface(s) 640 may support 3GPP reference points, such as Uu, N1, PC5, etc. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the processor 605 controls the user equipment apparatus 600 to implement the above-described UE behaviors. In certain embodiments, the processor 605 may include an application processor (also known as “main processor”) which manages application-domain and operating system (“OS”) functions and a baseband processor (also known as “baseband radio processor”) which manages radio functions.

In various embodiments, via the transceiver 625, the processor 605 receives a DCI scheduling UL resources for a HARQ retransmission at a first time-instance, where the DCI includes a first field indicating a CG configuration index. The processor 605 determines a HPID based on the CG configuration index signaled within the DCI and triggers a HARQ retransmission for a HARQ process corresponding to the determined HPID.

In some embodiments, determining the HPID based on the CG configuration index signaled within the DCI includes determining a HARQ process number associated with a last CG transmission with a same value as signaled by CG configuration index before the first time-instance. Here, the last CG transmission occasion belongs to a CG configuration corresponding to the CG configuration index.

In some embodiments, the first field includes a HARQ process number field. In certain embodiments, the DCI includes an indication to interpret the HARQ process number field as containing the CG configuration index. In certain embodiments, the indication to interpret the HARQ process number field as containing the CG configuration index includes a 1-bit flag.

In other embodiments, the indication to interpret the HARQ process number field as containing the CG configuration index includes a RNTI of the apparatus 600. In one embodiment, the DCI including a CS-RNTI scrambled by CRC indicates that the processor 605 is to interpret the HARQ process number field as containing a HARQ process number and where the DCI including a CG-specific RNTI (e.g., CS-CG-RNTI) scrambled by CRC indicates that the processor 605 is to interpret the HARQ process number field as containing the CG configuration index.

In some embodiments, the first field includes a dedicated field (e.g., ConfiguredGrantConfigIndex field). In some embodiments, the apparatus 600 is configured with a plurality of CG configurations, where the DCI further indicates a particular number of prior CG occasions across the plurality of CG configurations for which a retransmission is requested.

In some embodiments, the HARQ retransmission uses the UL resources in the first time-instance scheduled by the DCI. In some embodiments, when the DCI is received, the HARQ process corresponding to the determined HPID is triggered for autonomous retransmission during a next CG occasion, where the UL resources scheduled by the DCI include a DG.

In some embodiments, the DCI further includes a field indicating a particular CG occasion for which retransmission is requested, the particular CG occasion indicated from among a plurality of past CG occasions. In some embodiments, the processor 605 is further configured to cause the transceiver 625 to transmit, to the RAN, an indication that the apparatus 600 is capable of determining a respective HPID from a respective CG configuration index.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to dynamic retransmission for a failed CG transmission. For example, the memory 610 may store various parameters, panel/beam configurations, resource assignments, policies, and the like as described above. In certain embodiments, the memory 610 also stores program code and related data, such as an operating system or other controller algorithms operating on the user equipment apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 620 may include a wearable display separate from, but communicatively coupled to, the rest of the user equipment apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 communicates with one or more NFs of a mobile communication network via one or more access networks. The transceiver 625 operates under the control of the processor 605 to transmit messages, data, and other signals and also to receive messages, data, and other signals. For example, the processor 605 may selectively activate the transceiver 625 (or portions thereof) at particular times in order to send and receive messages.

The transceiver 625 includes at least transmitter 630 and at least one receiver 635. One or more transmitters 630 may be used to provide UL communication signals to a base unit 121, such as the UL transmissions described herein. Similarly, one or more receivers 635 may be used to receive DL communication signals from the base unit 121, as described herein. Although only one transmitter 630 and one receiver 635 are illustrated, the user equipment apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one more common control signals or as modular transmitters 630 and receivers 635 implemented in the same hardware chip or in a multi-chip module.

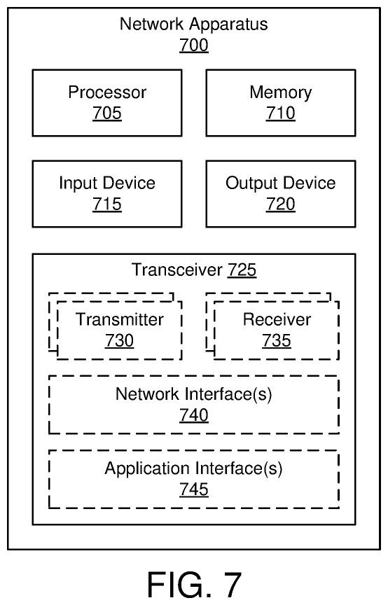

FIG. 7 depicts a network apparatus 700 that may be used for dynamic retransmission for a failed CG transmission, according to embodiments of the disclosure. In one embodiment, network apparatus 700 may be one implementation of a network endpoint, such as the base unit 121 and/or RAN node 210, as described above. Furthermore, the network apparatus 700 may include a processor 705, a memory 710, an input device 715, an output device 720, and a transceiver 725.

In some embodiments, the input device 715 and the output device 720 are combined into a single device, such as a touchscreen. In certain embodiments, the network apparatus 700 may not include any input device 715 and/or output device 720. In various embodiments, the network apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more remote units 105. Additionally, the transceiver 725 may support at least one network interface 740 and/or application interface 745. The application interface(s) 745 may support one or more APIs. The network interface(s) 740 may support 3GPP reference points, such as Uu, N1, N2 and N3. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a CPU, a GPU, an auxiliary processing unit, a FPGA, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the network apparatus 700 is a RAN node (e.g., a gNB) that communicates with one or more UEs, as described herein. In such embodiments, the processor 705 controls the network apparatus 700 to perform the above-described RAN behaviors. In some embodiments, the network apparatus 700 may configure one or more endpoint devices with the Training Sequences to be used in the key verification procedure. When operating as a RAN node, the processor 705 may include an application processor (also known as “main processor”) which manages application-domain and OS functions and a baseband processor (also known as “baseband radio processor”) which manages radio functions.

In various embodiments, processor 705 determines a CG configuration index corresponding to a particular HARQ process of the UE device. Via the transceiver 725, the processor 705 transmits, to the UE device, a DCI scheduling UL resources for a HARQ retransmission at a first time-instance, where the DCI includes a first field indicating the CG configuration index. Further, via the transceiver 725, the processor 705 monitors for a HARQ retransmission from the UE device for the particular HARQ process.

In some embodiments, the first field includes a HARQ process number field. In certain embodiments, the DCI includes an indication to interpret the HARQ process number field as containing the CG configuration index. In certain embodiments, the indication to interpret the HARQ process number field as containing the CG configuration index includes a 1-bit flag.

In other embodiments, the indication to interpret the HARQ process number field as containing the CG configuration index includes a RNTI of the UE device. In one embodiment, the DCI including a CS-RNTI scrambled by CRC indicates that the UE device is to interpret the HARQ process number field as containing a HARQ process number and where the DCI including a CG-specific RNTI (e.g., CS-CG-RNTI) scrambled by CRC indicates that the UE device is to interpret the HARQ process number field as containing the CG configuration index.

In some embodiments, the first field includes a dedicated field (e.g., ConfiguredGrantConfigIndex field). In some embodiments, the UE device is configured with a plurality of CG configurations, where the DCI further indicates a particular number of prior CG occasions across the plurality of CG configurations for which a retransmission is requested.

In some embodiments, the HARQ retransmission uses the UL resources in the first time-instance scheduled by the DCI. In some embodiments, the DCI further includes a field indicating a particular CG occasion for which retransmission is requested, the particular CG occasion indicated from among a plurality of past CG occasions.

In some embodiments, the transceiver 725 receives, from the UE device, an indication that the UE device is capable of determining a respective HPID from a respective CG configuration index. In some embodiments, the transceiver 725 receives, from the UE device, an indication that the UE device is capable of determining a respective HPID from subframe index of a respective CG occasion.

The memory 710, in one embodiment, is a computer readable storage medium. In some embodiments, the memory 710 includes volatile computer storage media. For example, the memory 710 may include a RAM, including DRAM, SDRAM, and/or SRAM. In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to dynamic retransmission for a failed CG transmission. For example, the memory 710 may store parameters, configurations, resource assignments, policies, and the like, as described above. In certain embodiments, the memory 710 also stores program code and related data, such as an operating system or other controller algorithms operating on the network apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the network apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least transmitter 730 and at least one receiver 735. One or more transmitters 730 may be used to communicate with the UE, as described herein. Similarly, one or more receivers 735 may be used to communicate with NFs in the PLMN and/or RAN, as described herein. Although only one transmitter 730 and one receiver 735 are illustrated, the network apparatus 700 may have any suitable number of transmitters 730 and receivers 735. Further, the transmitter(s) 730 and the receiver(s) 735 may be any suitable type of transmitters and receivers.

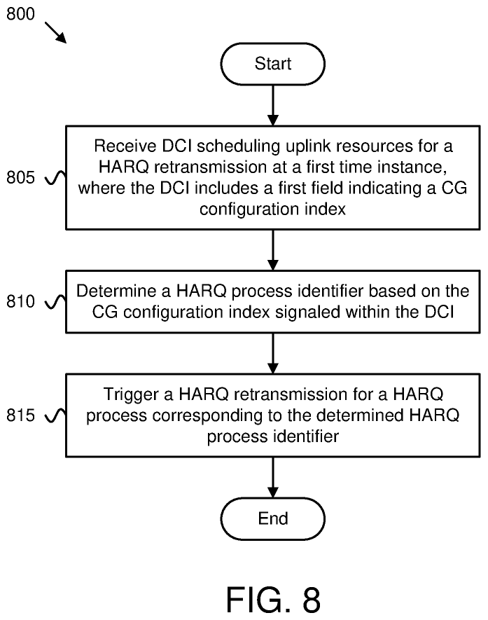

FIG. 8 depicts one embodiment of a method 800 for dynamic retransmission for a failed CG transmission, according to embodiments of the disclosure. In various embodiments, the method 800 is performed by a communication device, such as a remote unit 105, a UE 205, and/or the user equipment apparatus 600, described above. In some embodiments, the method 800 is performed by a processor, such as a microcontroller, a microprocessor, a CPU, a GPU, an auxiliary processing unit, a FPGA, or the like.

The method 800 begins and receives 805 DCI scheduling UL resources for a HARQ retransmission at a first time-instance, where the DCI includes a first field indicating a CG configuration index. The method 800 includes determining 810 a HPID based on the CG configuration index signaled within the DCI. The method 800 includes triggering 815 a HARQ retransmission for a HARQ process corresponding to the determined HPID. The method 800 ends.

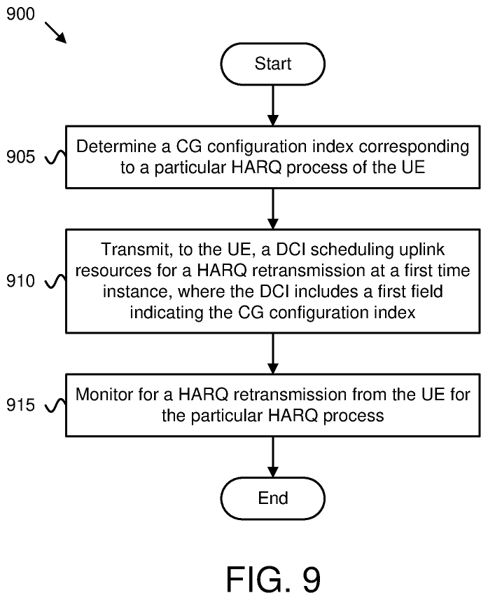

FIG. 9 depicts one embodiment of a method 900 for dynamic retransmission for a failed CG transmission, according to embodiments of the disclosure. In various embodiments, the method 900 is performed by a network device, such as the base unit 121, the RAN node 210, and/or the network apparatus 700, described above, as described above. In some embodiments, the method 900 is performed by a processor, such as a microcontroller, a microprocessor, a CPU, a GPU, an auxiliary processing unit, a FPGA, or the like.

The method 900 begins and determines 905 a CG configuration index corresponding to a particular HARQ process of the UE. The method 900 includes transmitting 910, to the UE, a DCI scheduling UL resources for a HARQ retransmission at a first time-instance. Here, the DCI includes a first field indicating the CG configuration index. The method 900 includes monitoring 915 for a HARQ retransmission from the UE for the particular HARQ process. The method 900 ends.

Disclosed herein is a first apparatus for dynamic retransmission for a failed CG transmission, according to embodiments of the disclosure. The first apparatus may be implemented by a communication device, such as a remote unit 105, a UE 205, and/or the user equipment apparatus 600, described above. The first apparatus includes a processor coupled to a transceiver, the transceiver configured to communicate with a RAN and the processor configured to cause the apparatus to: A) receive a DCI scheduling UL resources for a HARQ retransmission at a first time-instance, where the DCI includes a first field indicating a CG configuration index; B) determine a HPID based on the CG configuration index signaled within the DCI; and C) trigger a HARQ retransmission for a HARQ process corresponding to the determined HPID.

In some embodiments, to determine the HPID based on the CG configuration index signaled within the DCI, the processor is configured to determine a HARQ process number associated with a last CG transmission transmitted before the first time-instance with a same value as the CG configuration index. Here, the last CG transmission occasion belongs to a CG configuration corresponding to the CG configuration index.

In some embodiments, the first field includes a HARQ process number field. In certain embodiments, the DCI includes an indication to interpret the HARQ process number field as containing the CG configuration index. In certain embodiments, the indication to interpret the HARQ process number field as containing the CG configuration index includes a 1-bit flag.

In other embodiments, the indication to interpret the HARQ process number field as containing the CG configuration index includes a RNTI of the first apparatus. In one embodiment, the DCI including a CS-RNTI scrambled by CRC indicates that the first apparatus is to interpret the HARQ process number field as containing a HARQ process number and where the DCI including a CG-specific RNTI (e.g., CS-CG-RNTI) scrambled by CRC indicates that the first apparatus is to interpret the HARQ process number field as containing the CG configuration index.

In some embodiments, the first field includes a dedicated field (e.g., ConfiguredGrantConfigIndex field). In some embodiments, the first apparatus is configured with a plurality of CG configurations, where the DCI further indicates a particular number of prior CG occasions across the plurality of CG configurations for which a retransmission is requested.

In some embodiments, the HARQ retransmission uses the UL resources in the first time-instance scheduled by the DCI. In some embodiments, when the DCI is received, the HARQ process corresponding to the determined HPID is triggered for autonomous retransmission during a next CG occasion, where the UL resources scheduled by the DCI include a DG.

In some embodiments, the DCI further includes a field indicating a particular CG occasion for which retransmission is requested, the particular CG occasion indicated from among a plurality of past CG occasions. In some embodiments, the processor is further configured to cause the apparatus to transmit, to the RAN, an indication that the first apparatus is capable of determining a respective HPID from a respective CG configuration index.

Disclosed herein is a first method for dynamic retransmission for a failed CG transmission, according to embodiments of the disclosure. The first method may be performed by a communication device, such as a remote unit 105, a UE 205, and/or the user equipment apparatus 600, described above. The first method includes receiving, at the communication device, DCI scheduling UL resources for a HARQ retransmission at a first time-instance, where the DCI includes a first field indicating a CG configuration index. The first method includes determining, by the communication device, a HPID based on the CG configuration index signaled within the DCI and triggering, at the communication device, a HARQ retransmission for a HARQ process corresponding to the determined HPID.

In some embodiments, determining the HPID based on the CG configuration index signaled within the DCI includes determining a HARQ process number associated with a last CG transmission transmitted before the first time-instance with a same value as the CG configuration index. Here, the last CG transmission occasion belongs to a CG configuration corresponding to the CG configuration index.

In some embodiments, the first field includes a HARQ process number field. In certain embodiments, the DCI includes an indication to interpret the HARQ process number field as containing the CG configuration index. In certain embodiments, the indication to interpret the HARQ process number field as containing the CG configuration index includes a 1-bit flag.

In other embodiments, the indication to interpret the HARQ process number field as containing the CG configuration index includes a RNTI of the communication device. In one embodiment, the DCI including a CS-RNTI scrambled by CRC indicates that the communication device is to interpret the HARQ process number field as containing a HARQ process number and where the DCI including a CG-specific RNTI (e.g., CS-CG-RNTI) scrambled by CRC indicates that the communication device is to interpret the HARQ process number field as containing the CG configuration index.

In some embodiments, the first field includes a dedicated field (e.g., ConfiguredGrantConfigIndex field). In some embodiments, the communication device is configured with a plurality of CG configurations, where the DCI further indicates a particular number of prior CG occasions across the plurality of CG configurations for which a retransmission is requested.

In some embodiments, the HARQ retransmission uses the UL resources in the first time-instance scheduled by the DCI. In some embodiments, when the DCI is received, the HARQ process corresponding to the determined HPID is triggered for autonomous retransmission during a next CG occasion, where the UL resources scheduled by the DCI include a DG.

In some embodiments, the DCI further includes a field indicating a particular CG occasion for which retransmission is requested, the particular CG occasion indicated from among a plurality of past CG occasions. In some embodiments, the first method further includes transmitting, to the RAN, an indication that the communication device is capable of determining a respective HPID from a respective CG configuration index.

Disclosed herein is a second apparatus for dynamic retransmission for a failed CG transmission, according to embodiments of the disclosure. The second apparatus may be implemented by an access network device, such as the base unit 121, the RAN node 210, and/or the network apparatus 700, described above. The second apparatus includes a processor coupled to a transceiver, the transceiver configured to communicate with a mobile communication network and the processor configured to cause the apparatus to: A) determine a CG configuration index corresponding to a particular HARQ process of the UE; B) transmit, to the UE, a DCI scheduling UL resources for a HARQ retransmission at a first time-instance, where the DCI includes a first field indicating the CG configuration index; and C) monitor for a HARQ retransmission from the UE for the particular HARQ process.

In some embodiments, the first field includes a HARQ process number field. In certain embodiments, the DCI includes an indication to interpret the HARQ process number field as containing the CG configuration index. In certain embodiments, the indication to interpret the HARQ process number field as containing the CG configuration index includes a 1-bit flag.

In other embodiments, the indication to interpret the HARQ process number field as containing the CG configuration index includes a RNTI of the UE. In one embodiment, the DCI including a CS-RNTI scrambled by CRC indicates that the UE is to interpret the HARQ process number field as containing a HARQ process number and where the DCI including a CG-specific RNTI (e.g., CS-CG-RNTI) scrambled by CRC indicates that the UE is to interpret the HARQ process number field as containing the CG configuration index.

In some embodiments, the first field includes a dedicated field (e.g., ConfiguredGrantConfigIndex field). In some embodiments, the UE is configured with a plurality of CG configurations, where the DCI further indicates a particular number of prior CG occasions across the plurality of CG configurations for which a retransmission is requested.

In some embodiments, the HARQ retransmission uses the UL resources in the first time-instance scheduled by the DCI. In some embodiments, the DCI further includes a field indicating a particular CG occasion for which retransmission is requested, the particular CG occasion indicated from among a plurality of past CG occasions.

In some embodiments, the processor is further configured to cause the apparatus to receive, from the UE, an indication that the UE is capable of determining a respective HPID from a respective CG configuration index. In some embodiments, the processor is further configured to cause the apparatus to receive, from the UE, an indication that the UE is capable of determining a respective HPID from subframe index of a respective CG occasion.

Disclosed herein is a second method for dynamic retransmission for a failed CG transmission, according to embodiments of the disclosure. The second method may be performed by an access network device, such as the base unit 121, the RAN node 210, and/or the network apparatus 700, described above. The second method includes determining a CG configuration index corresponding to a particular HARQ process of the UE and transmitting, to the UE, a DCI scheduling UL resources for a HARQ retransmission at a first time-instance. Here, the DCI includes a first field indicating the CG configuration index. The second method includes monitoring for a HARQ retransmission from the UE for the particular HARQ process.

In some embodiments, the first field includes a HARQ process number field. In certain embodiments, the DCI includes an indication to interpret the HARQ process number field as containing the CG configuration index. In certain embodiments, the indication to interpret the HARQ process number field as containing the CG configuration index includes a 1-bit flag.

In other embodiments, the indication to interpret the HARQ process number field as containing the CG configuration index includes a RNTI of the UE. In one embodiment, the DCI including a CS-RNTI scrambled by CRC indicates that the UE is to interpret the HARQ process number field as containing a HARQ process number and where the DCI including a CG-specific RNTI (e.g., CS-CG-RNTI) scrambled by CRC indicates that the UE is to interpret the HARQ process number field as containing the CG configuration index.

In some embodiments, the first field includes a dedicated field (e.g., a ConfiguredGrantConfigIndex field). In some embodiments, the UE is configured with a plurality of CG configurations, where the DCI further indicates a particular number of prior CG occasions across the plurality of CG configurations for which a retransmission is requested.

In some embodiments, the HARQ retransmission uses the UL resources in the first time-instance scheduled by the DCI. In some embodiments, the DCI further includes a field indicating a particular CG occasion for which retransmission is requested, the particular CG occasion indicated from among a plurality of past CG occasions.

In some embodiments, the second method includes receiving, from the UE, an indication that the UE is capable of determining a respective HPID from a respective CG configuration index. In some embodiments, the second method further includes receiving, from the UE, an indication that the UE is capable of determining a respective HPID from a subframe index of a CG occasion.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A User Equipment (“UE”) apparatus comprising:
a transceiver configured to communicate with a radio access network (“RAN”); and
a processor coupled to the transceiver, the processor configured to cause the apparatus to:
receive a downlink control information (“DCI”) scheduling uplink resources for a Hybrid Automatic Repeat Request (“HARQ”) retransmission at a first time-instance, wherein the DCI comprises a first field indicating a configured grant (“CG”) configuration index;
determine a HARQ process identifier (“HPID”) based on the CG configuration index signaled within the DCI; and
trigger a HARQ retransmission for a HARQ process corresponding to the determined HPID.

2. The apparatus of claim 1, wherein, to determine the HPID based on the CG configuration index signaled within the DCI, the processor is configured to determine a HARQ process number associated with a last CG transmission transmitted before the first time-instance with a same value as the CG configuration index, the last CG transmission occasion belonging to a CG configuration corresponding to the CG configuration index.

3. The apparatus of claim 1, wherein the first field comprises a HARQ process number field.

4. The apparatus of claim 3, wherein the DCI comprises an indication to interpret the HARQ process number field as containing the CG configuration index.

5. The apparatus of claim 4, wherein the indication to interpret the HARQ process number field as containing the CG configuration index comprises a Radio Network Temporary Identifier (“RNTI”) of the apparatus.

6. The apparatus of claim 1, wherein the first field comprises a dedicated field.

7. The apparatus of claim 1, wherein the apparatus is configured with a plurality of CG configurations, wherein the DCI further indicates a particular number of prior CG occasions across the plurality of CG configurations for which a retransmission is requested.

8. The apparatus of claim 1, wherein the HARQ retransmission uses the uplink resources in the first time-instance scheduled by the DCI.

9. The apparatus of claim 1, wherein, when the DCI is received, the HARQ process corresponding to the determined HPID is triggered for autonomous retransmission during a next CG occasion, wherein the uplink resources scheduled by the DCI comprise a dynamic grant.

10. The apparatus of claim 1, wherein the DCI further comprises a field indicating a particular CG occasion for which retransmission is requested, the particular CG occasion indicated from among a plurality of past CG occasions.

11. The apparatus of claim 1, wherein the processor is further configured to cause the apparatus to transmit, to the RAN, an indication that the UE is capable of determining a respective HPID from a respective CG configuration index.

12. A method comprising:
receiving, at a User Equipment (“UE”) device, downlink control information (“DCI”) scheduling uplink resources for a Hybrid Automatic Repeat Request (“HARQ”) retransmission at a first time-instance, wherein the DCI comprises a first field indicating a configured grant (“CG”) configuration index;
determining, by the UE device, a HARQ process identifier (“HPID”) based on the CG configuration index signaled within the DCI; and
triggering, at the UE device, a HARQ retransmission for a HARQ process corresponding to the determined HPID.

13. A network apparatus comprising:
a transceiver configured to communicate with a User Equipment (“UE”) device; and
a processor coupled to the transceiver, the processor configured to cause the apparatus to:
determine a configured grant (“CG”) configuration index corresponding to a particular Hybrid Automatic Repeat Request (“HARQ”) process of the UE device;
transmit, to the UE device, a downlink control information (“DCI”) scheduling uplink resources for a Hybrid Automatic Repeat Request (“HARQ”) retransmission at a first time-instance, wherein the DCI comprises a first field indicating the CG configuration index; and
monitor for a HARQ retransmission from the UE device for the particular HARQ process.

14. The apparatus of claim 13, wherein the first field comprises a HARQ process number field, wherein the DCI comprises an indication to interpret the HARQ process number field as containing the CG configuration index.

15. The apparatus of claim 13, wherein the processor is further configured to cause the apparatus to receive, from the UE device, an indication that the UE device is capable of determining a respective HARQ process identifier from a respective CG configuration index.
